(19) United States
(12) Patent Application Publication
(10) Pub. No.: US 2026/0117705 A1
(43) Pub. Date: Apr. 30, 2026

(54) Attritable Torch Ignition System

(71) Applicant: Collins Engine Nozzles, Inc, Des Moines, IA (US)

(72) Inventors: Brandon WILLIAMS, Johnston, IA (US); Jared J. RICHARDS, Mingo, IA (US); Jason A. RYON, Carlisle, IA (US); Andy TIBBS, Earlham, IA (US); Philip BUELOW, West Des Moines, IA (US)

(21) Appl. No.: 18/933,297

(22) Filed: Oct. 31, 2024

(51) Int. Cl. F02C 7/266; F02C 7/232; F02C 9/28; F16K 31/06

(52) U.S. Cl. CPC F02C 7/266; F02C 7/232; F02C 9/28; F16K 31/0603

(57) ABSTRACT

Apparatus and associated methods relate to an attritable torch ignition system for a gas turbine engine. The attritable torch ignition system includes a fuel pre-heating component, a solenoid valve and an ignition controller. The ignition controller is configured to cause the solenoid valve to direct fuel to the pre-heating component during an ignition phase and to direct stop fuel from being directed to the fuel pre-heating component after the fuel has ignited. Ignition is caused when preheated fuel is mixed with air with sufficient energy from the heating element and directed into a combustion chamber of the gas turbine engine.

### BACKGROUND

The present disclosure relates to fuel pre-heating, and in particular to fuel pre-heating within a gas turbine engine.

Gas turbine engines inject fuel and air into combustion chambers to power the engine. Fuel properties (especially viscosity) change substantially with temperature. This can cause changes in atomization of the fuel. This is especially important for specific engine features such as ignition and altitude relight of a gas turbine engine. It is also especially important when considering atomization using pressure atomizers or discrete jet atomizers. Efficient atomization helps operate an engine and use less fuel.

### SUMMARY

Some embodiments relate to an attritable torch ignition system for a gas turbine engine. The attritable torch ignition system includes a fuel pre-heating component, a solenoid valve, and an ignition controller. The fuel pre-heating component has a component housing extending, around a central axis, from a first end to a second end. The component housing includes an inner chamber. The fuel pre-heating component also has a heating element positioned inside the inner chamber and an internal fuel channel disposed within the component housing and configured to be heated by the heating element. The solenoid valve is configured to selectively direct fuel to the fuel pre-heating component. The ignition controller is configured to cause the solenoid valve to direct fuel to the pre-heating component during an ignition phase and to cause the solenoid valve to stop fuel from being directed to the fuel pre-heating component after the fuel has ignited.

Some embodiments relate to a system for fuel injection in a gas turbine engine. The system includes a main combustor housing, a combustion chamber within the main combustor housing, and at least one main fuel injector extending through a wall of the combustion chamber. The system further includes a fuel pre-heating component further having a component housing, a heating element, and an internal fuel channel. The component housing extends, around a central axis, from a first end to a second end. The component housing includes an inner chamber. The heating element is positioned inside the inner chamber. The internal fuel channel is disposed within the component housing and configured to be heated by the heating element. The system also has a solenoid valve configured to selectively direct fuel to the fuel pre-heating component. The system also has an ignition controller configured to cause the solenoid valve to direct fuel to the pre-heating component during an ignition phase and to cause the solenoid valve to stop fuel from being directed to the fuel pre-heating component after the fuel has ignited.

### BRIEF DESCRIPTION OF THE DRAWINGS

FIG. 1 is a cross-sectional view of a fuel pre-heating component with internal fuel channels.

FIG. 2 is a cross-sectional view of a fuel pre-heating component with air passageways and fuel injection channels.

FIG. 3 is a phantom view of the fuel pre-heating component of FIG. 2.

FIG. 4. is a cross-sectional view of the fuel pre-heating component of FIG. 2-3 with a temperature controller.

FIG. 5 is a cross-sectional view of a fuel pre-heating component within a system for fuel injection in a gas turbine engine.

FIG. 6 is a cross-sectional view of a fuel pre-heating component mounted through a combustion chamber wall in a system for fuel injection in a gas turbine engine.

FIG. 7 is a cross-sectional view of a fuel pre-heating component mounted on a torch combustor within a system for fuel injection in a gas turbine engine.

FIG. 8 is a cross-sectional view of an attritable torch ignition system for a gas turbine engine.

FIG. 9 is a graph depicting timing of the switching of fuel from the pre-heating component to fuel injectors of the gas turbine engine.

While the above-identified figures set forth embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps and/or components not specifically shown in the drawings.

### DETAILED DESCRIPTION

Apparatus and associated methods relate to an attritable torch ignition system for a gas turbine engine. The attritable torch ignition system includes a fuel pre-heating component, a solenoid valve and an ignition controller. The ignition controller is configured to cause the solenoid valve to direct fuel to the pre-heating component during an ignition phase and to direct stop fuel from being directed to the fuel pre-heating component after the fuel has ignited. Ignition is caused when preheated fuel is mixed with air with sufficient energy from the heating element and directed into a combustion chamber of the gas turbine engine.

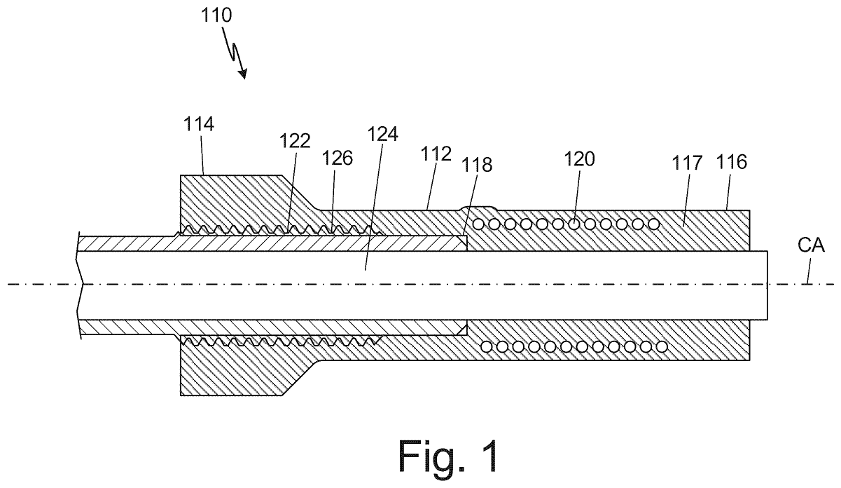

FIG. 1 is a cross-sectional view of a fuel pre-heating component 110. Fuel pre-heating component 110 may include component housing 112 with first end 114, second end 116, and walls 117 defining inner chamber 118, inner fuel channels 120, and first threaded section 122. Pre-heating component 110 can further include heating element 124 with second threaded section 126.

As discussed above, fuel pre-heating component 110 may include component housing 112 with a first end 114, second end 116, and walls 117 which define an inner chamber 118 extending along central axis CA. Component housing 112 has inner fuel channels 120 within it, and first threaded section 122 within inner chamber 118 at first end 114. The heating element 124 is configured to be inserted into inner chamber 118 and attach to component housing 112 via second threaded section 126 of heating element 124. First threaded section 122 interfaces with second threaded section 126 to hold heating element 124 in place. It is contemplated that other means of securing heating element 124 within component housing 112 may be used, such as welding or brazing. Heating element 124 can reach from first end 114 of fuel pre-heating component 110 and project out of second end 116 of fuel pre-heating element 110 or can span any other portion of the fuel pre-heating element 110 that is appropriate for a particular application. Heating element 124 can be any suitable heating device, such as an electrical resistance heating device (e.g., a glow plug) or any other heating device deemed appropriate for a particular application. In some examples, the heating element 124 can be supplemented with an ignition source such as a spark, plasma, or the tip of a glow plug as discussed further below. The ignition source can be either the surface of the glow plug already used as the preheater for the system, or alternatively a high voltage spark or plasma. Once the combustion reaction is initiated, the heat from the reaction may be able to sustain stable combustion without the need for additional input heat. The ignition source could be continuously on or activated only when needed to initiate combustion reaction.

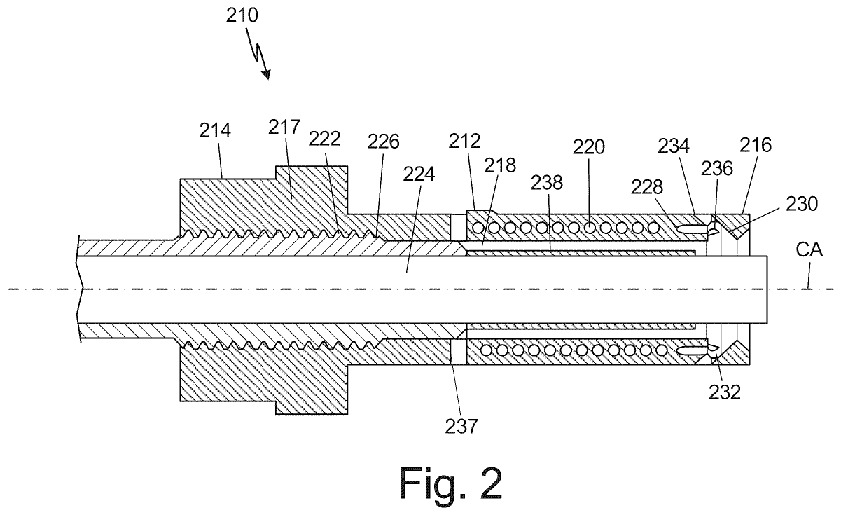

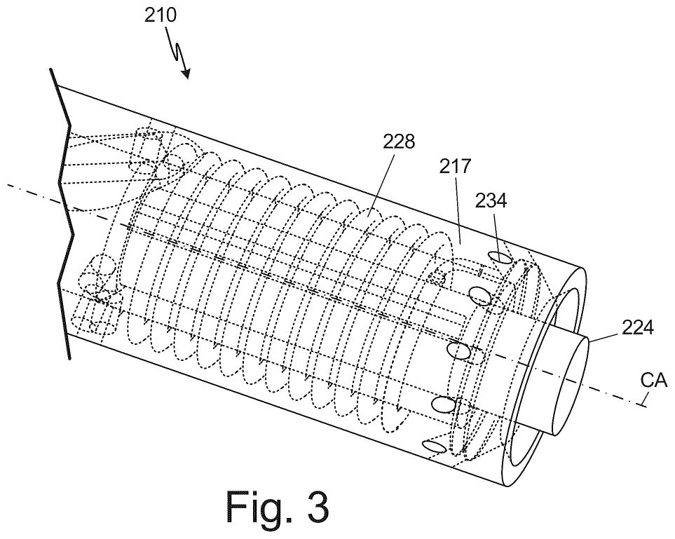

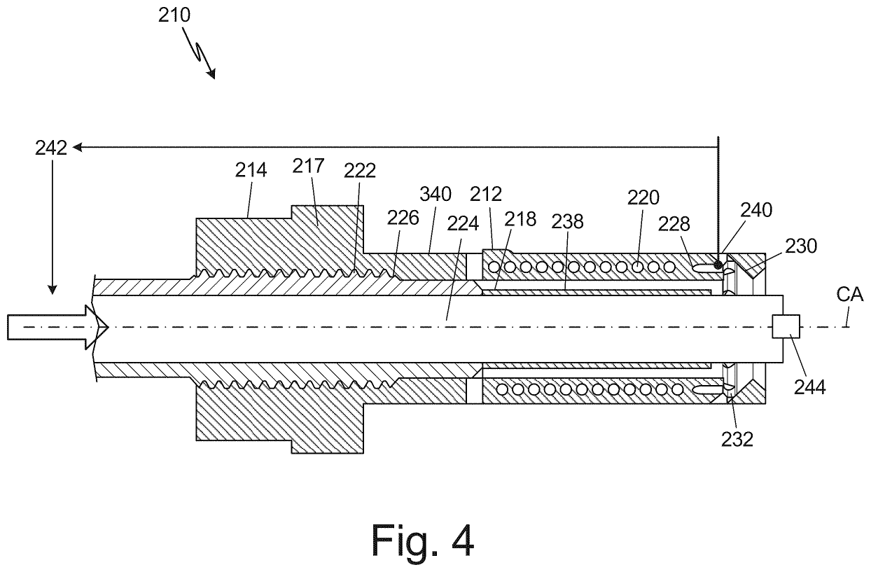

FIG. 2 is a cross-sectional view of another exemplary embodiment of a fuel pre-heating component 210. FIG. 3 is a phantom view of the fuel pre-heating component of FIG. 2. FIG. 4. is a cross-sectional view of the fuel pre-heating component of FIG. 2-3. FIG. 2-4 will be discussed together.

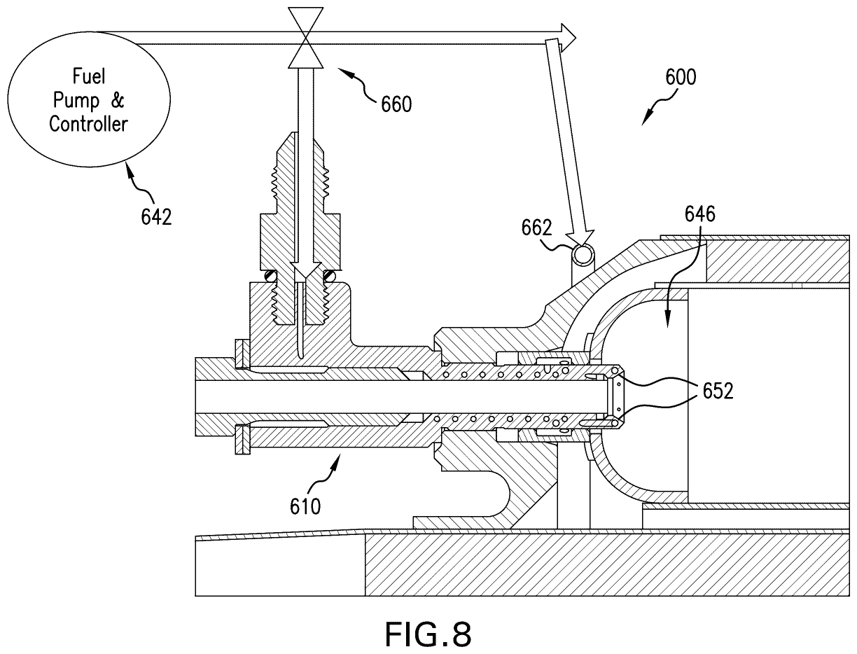

Fuel pre-heating component 210 can include component housing 212 with first end 214, second end 216, and walls 217 defining inner chamber 218, inner fuel channels 220, and first threaded section 222. Pre-heating component 210 can further include heating element 224 with second threaded section 226, fuel injection channels 228, splash plates 230, fuel openings 232, first air passageways 234, air entrances 236, upstream air entrances 237, and second air passageways 238. Pre-heating component 210 can further include fuel temperature sensor 240 configured to provide a metric of temperature of fuel near fuel openings 232 to ignition controller 242, which will be described below with reference to FIG. 8, and ignition sources 244 (as shown in FIG. 4).

As discussed above, fuel pre-heating component 210 may include component housing 212 with a first end 214, second end 216, and walls 217 which define an inner chamber 218 extending along central axis CA. Component housing 212 has inner fuel channels 220 within it, and first threaded section 222 within inner chamber 218 at first end 214. The heating element 224 is configured to insert into inner chamber 218 and attach to component housing 212 via second threaded section 226 of heating element 224. First threaded section 222 interfaces with second threaded section 226 to hold heating element 224 in place. Fuel injection channels 228 extend through component housing 212 and enter inner chamber 218 at second end 216 of fuel pre-heating component 210 through fuel openings 232. Fuel openings 232 can directly oppose splash plates 230 at second end 216 to direct fuel radially into inner chamber 218 and towards heating element 224. Fuel openings 232 can be configured to atomize fuel that impinges on the splash plates 230 after exiting fuel openings 232. In some examples, another form of atomization, such as pressure atomizers or discrete jet atomizers can be used in addition to or in place of splash plates 230 and fuel openings 232.

FIG. 2-4 further include first air passageways 234 which inject air or other fluid received via air entrances 236 into inner chamber 218 at second end 216 of fuel pre-heating component 210. In the illustrated embodiments, air openings 236 inject air parallel to splash plates 230, but it is contemplated that the angle of air injection can vary depending on desired mixing. It is also contemplated that upstream air entrances 237 can be disposed between first end 214 and inner fuel channels 220 (shown in FIG. 2). Second air passageways 238 run parallel to central axis CA to second end 216 and inject air at the same angle as fuel openings 232 in the illustrated embodiments. In some examples, these angles at which first and second air passageways 236 and 238 are directed can be selected to provide flow characteristics appropriate for a particular application. Second air passageways 238 help provide a buffer between heating element 224 and fuel channels 220 and 228. In FIG. 3, fuel channels 220 are positioned helically around inner chamber 218, thereby providing an increased surface area for heat transfer between heating element 224 and fuel within fuel channels 220. It is contemplated that fuel channels 220 can be wrapped helically around the central axis in a cylindrical layer, or in multiple cylindrical layers within walls 217 in cylindrical layers extending radially outward from central axis CA. In other examples, the fuel channels 220 can be positioned differently around inner chamber 218 as long as a desired heat transfer is realized between heating element 224 and fuel within fuel channels 220. In some examples, the helical channels (or channels with a different configuration) may also include air channels to preheat air for applications within a gas turbine engine. FIG. 4 depicts fuel temperature sensor 240 positioned at fuel opening 232 to monitor fuel temperature at this location. The temperature of the fuel can be transmitted from fuel temperature sensor 240 to ignition controller 242, which can vary power provided to heating element 224 to either increase or decrease the fuel temperature at fuel openings 232. If temperature of the fuel is too low, ignition can be more difficult due to high viscosity of the fuel, whereas if temperature is too high coking of fuel flowing through the fuel channels 220 and 228 can cause obstructions therewithin. In one example, ignition controller 242 can be configured to provide lower power to heating element 224 during a fuel pre-heating cycle and higher power during a fuel ignition cycle. For example, during a fuel pre-heating cycle it may be desirable to maintain fuel flowing through the fuel channel 228 at a temperature of 100° F. to 200° F. During a fuel ignition cycle it may be desirable to maintain fuel flowing through the fuel channel 228 at a temperature of 200° F. to 250° F. or more, depending on the coking propensity of the fuel being used.

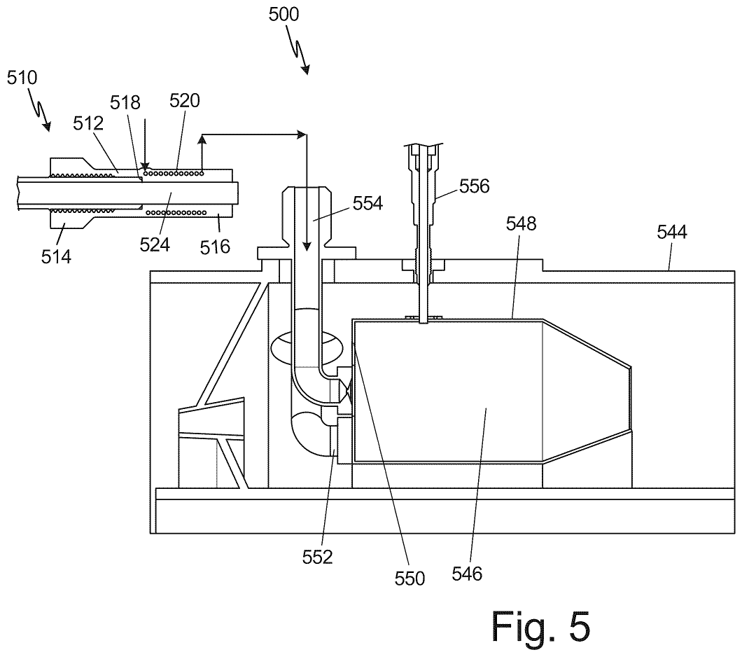

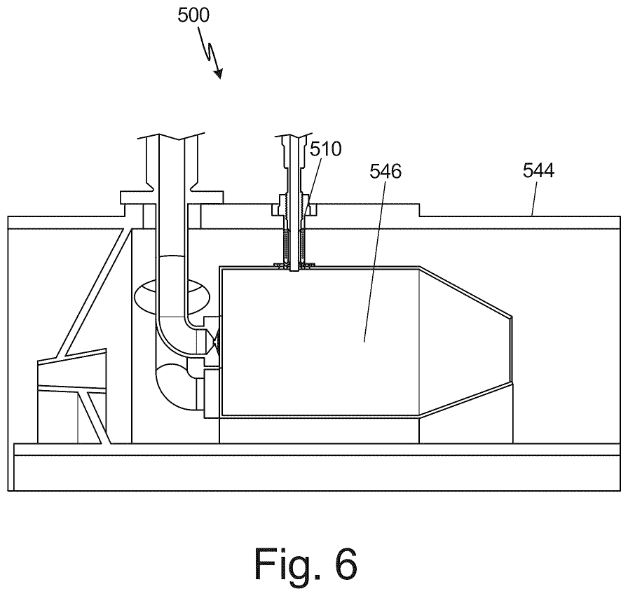

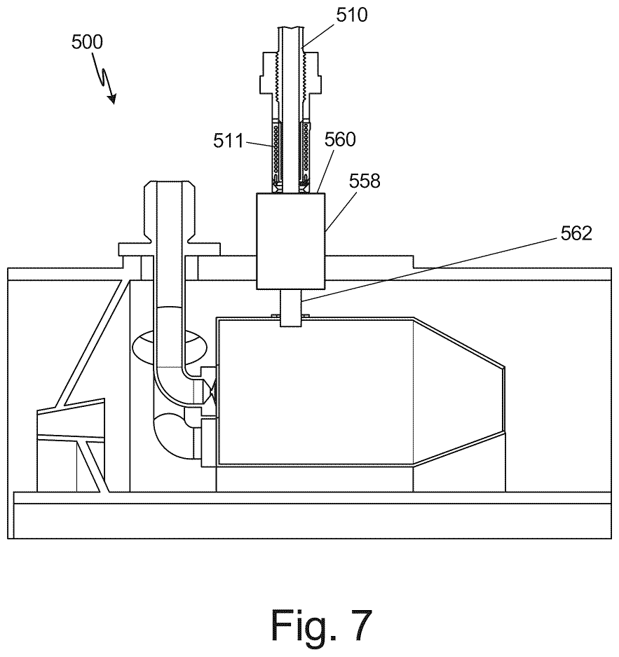

FIG. 5 is a cross-sectional view of a fuel pre-heating component within a system for fuel injection in a gas turbine engine. FIG. 6 is a cross-sectional view of a fuel pre-heating component mounted through a combustion chamber wall in a system for fuel injection in a gas turbine engine. FIG. 7 is a cross-sectional view of a fuel pre-heating component mounted on a torch combustor within a system for fuel injection in a gas turbine engine. FIG. 5-7 will be discussed together.

System 500 for fuel injection can include fuel pre-heating component 510, which can include component housing 512 with first end 514 and second end 516 defining inner chamber 518, and inner fuel channels 520. Pre-heating component 510 can further include heating element 524. The system can further include main combustor housing 544, combustion chamber 546 with walls 548 and back wall 550, main fuel injector 552, and main fuel passage 554. The system can further include ignition source 556 (FIG. 5) or torch combustor 558 (FIG. 7).

Main combustor housing 544 can contain combustion chamber 546. Combustion chamber 546 has liner walls 548 and back wall 550. Main fuel injector 552 can include main fuel passage 554 which extends through main combustor housing 544 and connects main fuel injector 552 to combustion chamber 546 at back wall 550. It is contemplated that more than one main fuel injector may be used, and that ignition source 556 can be mounted in top wall 548 of combustion chamber 546 (depicted in FIG. 5) or any other suitable location.

Fuel pre-heating component 510 can be located elsewhere within the gas turbine engine, as depicted in FIG. 5, or through main combustor housing 544 into the walls of the combustion chamber 546 (depicted in FIG. 6). Fuel pre-heating component 510 can also be located outside of main combustor housing 544 and attached at second end 516 to torch combustor 558 via first end 560 (depicted in FIG. 7). Torch combustor can extend through main combustor housing 544 and attach to combustion chamber 546 through the liner wall 548 via second end 562 of torch combustor.

FIG. 8 is a cross-sectional view of an attritable torch ignition system for a gas turbine engine. In FIG. 8, attritable torch ignition system 600 includes fuel pre-heating component 610, solenoid valve 660, and ignition controller 642. In the depicted embodiment, fuel can be injected into combustion chamber 646 via fuel pre-heating component 610 and/or via fuel line 662 which delivers fuel to main fuel injectors of the gas turbine engine. Fuel pre-heating component 610 is configured to inject heated fuel and/or heated air into combustion chamber 646 during an ignition phase of operation. Fuel pre-heating component 610 can also cause ignition of the mixture of heated fuel and/or heated air injected thereby, as is described above. Fuel pre-heating component 610 can be any of fuel pre-heating elements 110, 210, and 510, as depicted in FIGS. 1, 2 and 5, respectively.

Solenoid valve 660 is configured to selectively direct fuel to fuel pre-heating component 610. Typically, fuel is directed to fuel pre-heating component 610 during the ignition phase of operation of the gas turbine engine. Because pre-heating component 610 is typically needed only during certain engine cycle conditions, such as an ignition phase, fuel pre-heating component 610 is an attritable component, which can be permitted to operate throughout the operational phase of gas turbine engine, which can result in coking of fuel within fuel channels within fuel pre-heating component 610. Such coking of fuel within fuel channels within pre-heating component 610 can result in blocking of such channels, which may no longer be needed, as fuel is directed to combustion chamber 646 via the main fuel injectors.

Ignition controller 642 is configured to cause solenoid valve 660 to direct fuel to pre-heating component 610 during an ignition phase of operation. Ignition controller 642 can also be configured to cause solenoid valve 660 to stop fuel from being directed to fuel pre-heating component 610 after the fuel has ignited. Ignition controller 642 can initiate and/or terminate direction of fuel to pre-heating component 610 based on various metrics. For example, ignition controller 642 can cause solenoid valve 660 to direct fuel to pre-heating component 610 in response to a launch command. Ignition controller 642 can then cause solenoid valve 660 to stop fuel from being directed to fuel pre-heating component 610 in response to a time limit for directing fuel to the pre-heating component during an ignition phase. In other embodiments, ignition controller 642 is configured to cause solenoid valve 660 to stop fuel from being directed to fuel pre-heating component 610 in response to a combustion temperature indicative of combustion within the gas turbine engine. In such embodiments, a combustion temperature sensor can be configured to sense combustion temperature in combustion chamber 646 of the gas turbine engine. Ignition controller 642 can be in electrical communication with the combustion temperature sensor, thereby receiving a signal indicate of temperature within in or at combustion chamber 646.

In some embodiments, ignition controller 642 can be configured to regulate temperature of the fuel heated by fuel pre-heating component 610. In such embodiments, fuel pre-heating component 610 has a fuel temperature sensor (e.g., such as fuel temperature sensor 240 as depicted in FIG. 4), which can be proximate one of the one or more fuel openings (e.g. such as fuel openings 232 as depicted in FIGS. 2 and 4), through which heated fuel is injected into a combustion chamber of the gas turbine engine. Ignition controller can regulate power to a heating element (e.g., such as heating elements 124, 224, and 524 as depicted in FIGS. 1, 2, and 5, respectively). For example, upon a launch command for an airborne vehicle using an attritable torch ignition system, such as attritable torch ignition system 600, for example, ignition controller 642 can initiate heating of the heating element. In some embodiments, ignition controller 642 can control power of the heating element such that the fuel temperature is maintained within a specified range. In some embodiments, upon ignition, ignition controller 642 maintain power to the heating element if needed to maintain a flame, or turn off power to the heating element if the flame is self-sustaining. In some embodiments, if a cycle flame condition is detected which brings the combustion chamber close to the flame-out limit, then ignition controller 642 can turn power back on to the heating element so as to provide additional heat to the main combustor to maintain flame stability.

An example of how attritable torch ignition system 600 can operate will now be described. Attritable torch ignition system 600 may receive a launch command (or a pre-launch command) and respond thereto by: i) causing heating component 610 to begin heating operation; and ii) causing solenoid valve 660 to direct fuel to pre-heating component 610. Attritable torch ignition system 600 will then continue providing pre-heating of fuel in this fashion until sustainable ignition has been achieved. Attritable torch ignition system 600 might, for example, receive a signal indicate of temperature in combustion chamber 646. In response to the signal indicated a temperature indicative of fuel combustion, attritable torch ignition system 600 might respond thereto by: causing heating component 610 to stop heating operation; and ii) causing solenoid valve 660 to close, thereby terminating the directing of fuel to pre-heating component 610. In some embodiments, attritable torch ignition system 600 might continue to monitor temperature within combustion chamber 646. If temperature within combustion chamber 646 indicates that fuel is no longer combusting within combustion chamber 646, attritable torch ignition system 600 might respond by again: causing heating component 610 to begin heating operation; and ii) causing solenoid valve 660 to direct fuel to pre-heating component 610.

Using a fuel pre-heating component has several advantages over traditional gas turbine combustion systems. A consistently atomized fuel can lead to much more controllable starts. Pre-heating reduces the need for specialized ‘pilot’ or ‘starting’ fuel injectors, and further reduces the need for cold-fuel testing requirements of fuel injectors. This results in cleaner burning fuel with less coking within the combustion chamber. Pre-heating the fuel decreases the time to evaporation, helping to ensure more complete combustion, including fully consuming particulate matter (soot) created in the conversion of hydrocarbons to combustion productions.

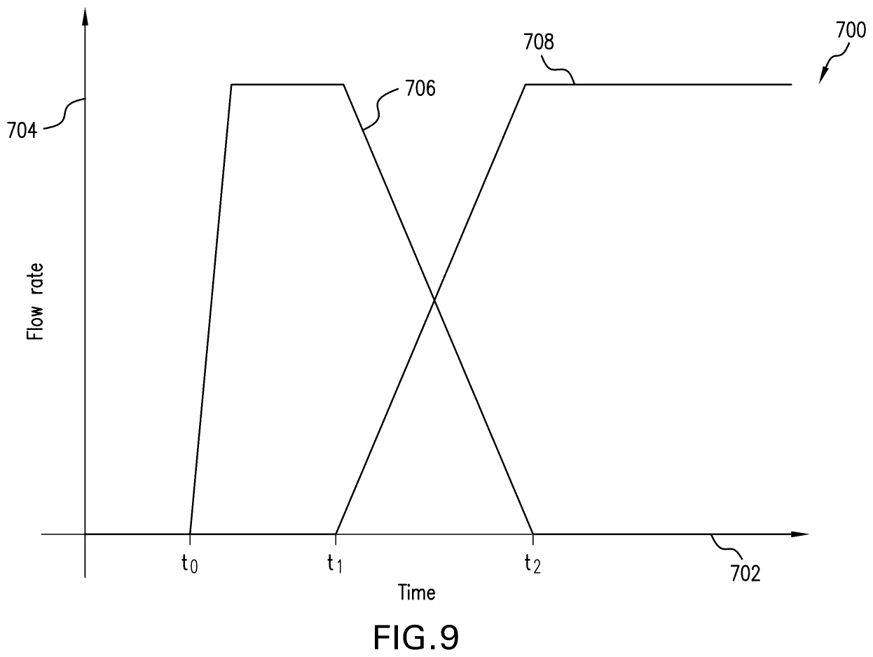

FIG. 9 is a graph depicting timing of the switching of fuel from the pre-heating component to fuel injectors of the gas turbine engine. In FIG. 9, graph 700 includes horizontal axis 702, vertical axis 704 and flow rate/time relations 706 and 708. Horizontal axis 702 is indicative of time, and vertical axis 704 is indicative of fuel flow rate. Flow rate/time relation 706 is indicative of the relation between fuel flow rate to fuel pre-heating component 610 as a function of time. Flow rate/time relation 708 is indicative of the relation between fuel flow rate to the main fuel injectors as a function of time. At time t₀, ignition controller 642 receives a launch command, and responds thereto by causing solenoid valve 660 to direct fuel to pre-heating component 610 during an ignition phase. Then, at time t₁, ignition controller 642 determines that ignition of fuel within combustion chamber 646 has commenced, and in response, ignition controller 642 begins to stop fuel from being directed to fuel pre-heating component 610 and to begin directing fuel to main fuel injectors. This cross-over between fuel being directed to fuel pre-heating component 610 and such fuel instead being directed to the main fuel injectors lasts until time t₂. Beginning at time t₂, fuel is no longer being directed to fuel pre-heating component 610. This non-abrupt transition by solenoid valve 660 operating in concert with ignition controller 642 permits continued ignition throughout the duration t₂-t₁ of fuel switchover.

### Discussion of Possible Embodiments

The following are non-exclusive descriptions of possible embodiments of the present invention.

Some embodiments relate to an attritable torch ignition system for a gas turbine engine. The attritable torch ignition system includes a fuel pre-heating component, a solenoid valve, and an ignition controller. The fuel pre-heating component has a component housing extending, around a central axis, from a first end to a second end. The component housing includes an inner chamber. The fuel pre-heating component also has a heating element positioned inside the inner chamber and an internal fuel channel disposed within the component housing and configured to be heated by the heating element. The solenoid valve is configured to selectively direct fuel to the fuel pre-heating component. The ignition controller is configured to cause the solenoid valve to direct fuel to the pre-heating component during an ignition phase and to cause the solenoid valve to stop fuel from being directed to the fuel pre-heating component after the fuel has ignited.

The attritable torch ignition system of the preceding paragraph can optionally include, additionally and/or alternatively, any one or more of the following features, configurations and/or additional components:

A further embodiment of the foregoing attritable torch ignition system, wherein the solenoid valve can be a three-way solenoid valve configured to selectively direct fuel from a fuel supply to the fuel pre-heating component and/or to main fuel injectors for the gas turbine engine.

A further embodiment of any of the foregoing attritable torch ignition systems, wherein the solenoid valve can be further configured to permit fuel flow to both the fuel pre-heating component and/or to main fuel injectors for the gas turbine engine during a switching event.

A further embodiment of any of the foregoing attritable torch ignition systems, wherein the fuel pre-heating component can further include: i) a fuel injection channel in the second end of the component housing; and ii) a splash plate directly opposing a fuel opening of the fuel injection channel into the inner chamber. The splash plate can be configured to atomize fuel impinging thereon.

A further embodiment of any of the foregoing attritable torch ignition systems, wherein the fuel pre-heating component can further include: i) a fuel opening through which heated fuel is injected into a combustion chamber of the gas turbine engine; and ii) a fuel temperature sensor proximate the fuel opening. The ignition controller can be in electrical communication with the fuel temperature sensor and is configured to vary power to the heating element to control the temperature of fuel in the fuel injection channel when the fuel pre-heating component is in operation.

A further embodiment of any of the foregoing attritable torch ignition systems, wherein the heating element can be an electrical resistance heating element.

A further embodiment of any of the foregoing attritable torch ignition systems can further include an ignition source within the inner chamber.

A further embodiment of any of the foregoing attritable torch ignition systems, wherein the internal fuel channel can be disposed helically around the central axis and the heating element.

A further embodiment of any of the foregoing attritable torch ignition systems can further include a combustion temperature sensor configured to sense combustion temperature in a combustion chamber of the gas turbine engine. The ignition controller can be in electrical communication with the combustion temperature sensor and can be configured to cause the solenoid valve to stop fuel from being directed to the fuel pre-heating component in response to a combustion temperature indicative of combustion within the gas turbine engine.

A further embodiment of any of the foregoing attritable torch ignition systems, wherein the ignition controller can be configured to cause the solenoid valve to stop fuel from being directed to the fuel pre-heating component in response to a time limit for directing fuel to the pre-heating component during the ignition phase.

Some embodiments relate to a system for fuel injection in a gas turbine engine. The system includes a main combustor housing, a combustion chamber within the main combustor housing, and at least one main fuel injector extending through a wall of the combustion chamber. The system further includes a fuel pre-heating component further having a component housing, a heating element, and an internal fuel channel. The component housing extends, around a central axis, from a first end to a second end. The component housing includes an inner chamber. The heating element is positioned inside the inner chamber. The internal fuel channel is disposed within the component housing and configured to be heated by the heating element. The system also has a solenoid valve configured to selectively direct fuel to the fuel pre-heating component. The system also has an ignition controller configured to cause the solenoid valve to direct fuel to the pre-heating component during an ignition phase and to cause the solenoid valve to stop fuel from being directed to the fuel pre-heating component after the fuel has ignited.

The system of the preceding paragraph can optionally include, additionally and/or alternatively, any one or more of the following features, configurations and/or additional components:

A further embodiment of the foregoing system, wherein the solenoid valve can be a three-way solenoid valve configured to selectively direct fuel from a fuel supply to the fuel pre-heating component and/or to main fuel injectors for the gas turbine engine.

A further embodiment of any of the foregoing systems, wherein the solenoid valve can be further configured to permit fuel flow to both the fuel pre-heating component and/or to main fuel injectors for the gas turbine engine during a switching event.

A further embodiment of any of the foregoing systems wherein the fuel pre-heating component can further include: i) a fuel injection channel in the second end of the component housing; and ii) a splash plate directly opposing a fuel opening of the fuel injection channel into the inner chamber. The splash plate can be configured to atomize fuel impinging thereon.

A further embodiment of any of the foregoing systems wherein the fuel pre-heating component can further include: i) a fuel opening through which heated fuel is injected into a combustion chamber of the gas turbine engine; and ii) a fuel temperature sensor proximate one of the fuel opening. The ignition controller can be in electrical communication with the fuel temperature sensor and can be configured to vary power to the heating element to control the temperature of fuel in the fuel injection channel when the fuel pre-heating component is in operation.

A further embodiment of any of the foregoing systems, wherein the heating element is an electrical resistance heating element.

A further embodiment of any of the foregoing systems can further include an ignition source within the inner chamber.

A further embodiment of any of the foregoing systems, wherein the internal fuel channel can be disposed helically around the central axis and the heating element.

A further embodiment of any of the foregoing systems can further include a combustion temperature sensor configured to sense combustion temperature in a combustion chamber of the gas turbine engine. The ignition controller can be in electrical communication with the combustion temperature sensor and can be configured to cause the solenoid valve to stop fuel from being directed to the fuel pre-heating component in response to a combustion temperature indicative of combustion within the gas turbine engine.

A further embodiment of any of the foregoing systems, wherein the ignition controller can be configured to cause the solenoid valve to stop fuel from being directed to the fuel pre-heating component in response to a time limit for directing fuel to the pre-heating component during an ignition phase.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An attritable torch ignition system for a gas turbine engine, the attritable torch ignition system comprising:
a fuel pre-heating component including:
a component housing extending, around a central axis, from a first end to a second end, wherein the component housing includes an inner chamber;
a heating element positioned inside the inner chamber; and
an internal fuel channel disposed within the component housing and configured to be heated by the heating element;
a solenoid valve configured to selectively direct fuel to the fuel pre-heating component; and
an ignition controller configured to cause the solenoid valve to direct fuel to the pre-heating component during an ignition phase and to cause the solenoid valve to stop fuel from being directed to the fuel pre-heating component after the fuel has ignited.

2. The attritable torch ignition system of claim 1, wherein the solenoid valve is a three-way solenoid valve configured to selectively direct fuel from a fuel supply to the fuel pre-heating component and/or to main fuel injectors for the gas turbine engine.

3. The attritable torch ignition system of claim 2, wherein the solenoid valve is further configured to permit fuel flow to both the fuel pre-heating component and/or to main fuel injectors for the gas turbine engine during a switching event.

4. The attritable torch ignition system of claim 1, wherein the fuel pre-heating component further includes:
a fuel injection channel in the second end of the component housing; and
a splash plate directly opposing a fuel opening of the fuel injection channel into the inner chamber, wherein the splash plate is configured to atomize fuel impinging thereon.

5. The attritable torch ignition system of claim 4, wherein the fuel pre-heating component further includes:
a fuel opening through which heated fuel is injected into a combustion chamber of the gas turbine engine; and
a fuel temperature sensor proximate the fuel opening, wherein:
the ignition controller is in electrical communication with the fuel temperature sensor and is configured to vary power to the heating element to control the temperature of fuel in the fuel injection channel when the fuel pre-heating component is in operation.

6. The attritable torch ignition system of claim 1, wherein the heating element is an electrical resistance heating element.

7. The attritable torch ignition system of claim 1, further comprising:
an ignition source within the inner chamber.

8. The attritable torch ignition system of claim 1, wherein the internal fuel channel is disposed helically around the central axis and the heating element.

9. The attritable torch ignition system of claim 1, further comprising:
a combustion temperature sensor configured to sense combustion temperature in a combustion chamber of the gas turbine engine, wherein:
the ignition controller is in electrical communication with the combustion temperature sensor and is configured to cause the solenoid valve to stop fuel from being directed to the fuel pre-heating component in response to a combustion temperature indicative of combustion within the gas turbine engine.

10. The attritable torch ignition system of claim 1, wherein:
the ignition controller is configured to cause the solenoid valve to stop fuel from being directed to the fuel pre-heating component in response to a time limit for directing fuel to the pre-heating component during the ignition phase.

11. A system for fuel injection in a gas turbine engine, the system comprising:
a main combustor housing;
a combustion chamber within the main combustor housing;
at least one main fuel injector extending through a wall of the combustion chamber;
a fuel pre-heating component further comprising:
a component housing extending, around a central axis, from a first end to a second end, wherein the component housing includes an inner chamber;
a heating element positioned inside the inner chamber; and
an internal fuel channel disposed within the component housing and configured to be heated by the heating element;
a solenoid valve configured to selectively direct fuel to the fuel pre-heating component; and
an ignition controller configured to cause the solenoid valve to direct fuel to the pre-heating component during an ignition phase and to cause the solenoid valve to stop fuel from being directed to the fuel pre-heating component after the fuel has ignited.

12. The system of claim 11, wherein the solenoid valve is a three-way solenoid valve configured to selectively direct fuel from a fuel supply to the fuel pre-heating component and/or to main fuel injectors for the gas turbine engine.

13. The system of claim 12, wherein the solenoid valve is further configured to permit fuel flow to both the fuel pre-heating component and/or to main fuel injectors for the gas turbine engine during a switching event.

14. The system of claim 11, wherein the fuel pre-heating component further includes:
a fuel injection channel in the second end of the component housing; and
a splash plate directly opposing a fuel opening of the fuel injection channel into the inner chamber, wherein the splash plates are configured to atomize fuel impinging thereon.

15. The system of claim 14, wherein the fuel pre-heating component further includes:
a fuel opening through which heated fuel is injected into a combustion chamber of the gas turbine engine; and
a fuel temperature sensor proximate one of the fuel opening, wherein:
the ignition controller is in electrical communication with the fuel temperature sensor and is configured to vary power to the heating element to control the temperature of fuel in the fuel injection channel when the fuel pre-heating component is in operation.

16. The system of claim 11, wherein the heating element is an electrical resistance heating element.

17. The system of claim 11, further comprising:
an ignition source within the inner chamber.

18. The system of claim 11, wherein the internal fuel channel is disposed helically around the central axis and the heating element.

19. The system of claim 11, further comprising:
a combustion temperature sensor configured to sense combustion temperature in a combustion chamber of the gas turbine engine, wherein:
the ignition controller is in electrical communication with the combustion temperature sensor and is configured to cause the solenoid valve to stop fuel from being directed to the fuel pre-heating component in response to a combustion temperature indicative of combustion within the gas turbine engine.

20. The system of claim 11, wherein:
the ignition controller is configured to cause the solenoid valve to stop fuel from being directed to the fuel pre-heating component in response to a time limit for directing fuel to the pre-heating component during an ignition phase.
